(19) United States
(12) Patent Application Publication
(10) Pub. No.: US 2003/0046248 A1
(43) Pub. Date: Mar. 6, 2003

(54) "SHIFT" (secure home interactive financial transactor) internet credit card security system and non-internet electronic banking system

(76) Inventor: Edward Federowicz, Bayonne, NJ (US)

Correspondence Address: EDWARD FEDEROWICZ, 98 WEST 32ND STREET, BAYONNE, NJ, 07002, US

(21) Appl. No.: 09/940,211

(22) Filed: Aug. 28, 2001

(51) Int. Cl. G06F 17/60

(52) U.S. Cl. 705/70

(57) ABSTRACT

“SHIFT”, is a radically different Credit Card Internet Security System that converts the current “Vendor Take From” system, to a “Cardholder Pay To” system, where purchases are made over the Internet, but where payments for the purchase are made with the use of the “SHIFT” Unit by the Cardholder over the Cardholder's home telephone line.

The “SHIFT” E-Commerce Security System employs an approximately two inch by four inch by three quarter inch device that contains a numeric keypad and eight or more additional activation keys, and has a twenty or more character LCD screen. It contains a battery backup system, with low battery warning light, an “on” warning light and in and out telephone jacks. It employs a data string consisting of seven or more fields that accept DTMF (Dual Tone Multi Frequency) inputs and the cover contains instructions for making a Credit Card Purchase.

The use of the disclosed “SHIFT” Internet Credit Card Security and Electronic Banking System by Credit Card issuers will drastically reduce (if not totally eliminate) Credit Card thefts and frauds, basically because no Credit Card numbers are ever given to any Vendor, on or off of the Internet.

The “SHIFT” System permits the Consumer to retain total control of what funds are disbursed from their Credit Card accounts, thereby generating absolute Consumer confidence that their Credit Card or Bank Account numbers will never be stolen and misused by “Hackers”. Such absolute Consumer confidence will result in virtually One Hundred Percent (100%) of Credit Card holders using their Cards on the Internet, which ought cause Internet sales to skyrocket.

The use of the disclosed “SHIFT” System for electronic banking by virtually anyone having a bank account, will bring electronic banking to the fruition contemplated by the Banking Industry. Because no computer is needed, virtually anyone can begin employing electronic banking to pay their bills and do their normal banking functions immediately, thereby saving the Consumer the costs of checks, stamps and envelopes and the banking Industry the cost of processing paper checks.

“SHIFT”, a radically different Credit Card Internet Security System that converts the current “Vendor Take From” system, to a “Cardholder Pay To” system, where purchases are made over the Internet, but where payments for the purchase are made with the use of the “SHIFT” Unit by the Cardholder over the Cardholder's home telephone line is disclosed.

The “SHIFT” E-Commerce Security System employs an approximately two inch by four inch by three quarter inch device that contains a numeric keypad and eight or more additional activation keys, and has a twenty or more character LCD screen. It contains a battery backup system, with low battery warning light, an “on” warning light and in and out telephone jacks. It employs a data string consisting of seven fields that accept DTMF (Dual Tone Multi Frequency) inputs and the cover contains instructions for making a Credit Card Purchase.

The “SHIFT” E-Commerce Security System is an invention that because of converting the present “Vendor Take From System”, to a “Credit Card Holder Pay To System”, no Credit Card numbers are ever given over the Internet, thereby preventing any “hacker” theft or misuse of Credit Card numbers, which will serve to instill Consumer confidence to use Credit Cards or Bank Account Numbers to make purchases over the Internet because of the Consumer never giving out a Credit Card or Bank Account number to any Vendor.

This invention has every Vendor/Merchant/Individual (hereinafter “Vendor”) have a “Deposit Only Account Number” correlative to their bank account, in a configuration similar to current Credit Card numbers, with additional digits or a different number that would be employed to make withdrawals from the account.

With the use of the “SHIFT” Unit, the Consumer, after making an Internet or telephone purchase and supplying the Vendor with all vital shipping information and a phone number, except for a Credit Card or Bank Account number, electronically receives (using DTMF tones) into the “SHIFT” Unit, billing information consisting of the Vendor's “Deposit Only Account Number”; “Invoice Number” (future Invoice numbers will consist of the “date/hour/minute/second” that the order is sent to the Consumer—for multi station order taking systems, the number of the given station will also be part of the Invoice number); and “Price” of the given transaction.

The Vendor's “Deposit Only Account Number” and “Invoice Number” are deposited directly into two of the seven Fields in the “SHIFT” Unit data string. The “Price” of the given transaction is deposited to the “LCD” screen of the “SHIFT” Unit. The Consumer, while still connected to the Vendor, via phone or computer, is required to replicate the “Price” in the LCD, using the numeric keys on the “SHIFT” Unit. Only when the “Price” is exactly replicated, does that amount, as keyed in by the Consumer, then get deposited in one of the “fields” in the “SHIFT” Unit. (See Credit Card Purchase Flow Chart).

This feature ensures that the “Price” sent by the Vendor is correct and assures the Vendor that he will be sent the correct amount.

The Consumer, after terminating contact with the Vendor, (whether by telephone or computer), using the keys on the “SHIFT” Unit, or a “swipe” feature, enters a Credit Card/Expiration Date or Bank Account number and a PIN.

The Consumer thereafter employs a telephone number supplied by the Credit Card Issuer or Bank, (up to Ten (10) telephone number memory cells can be added to the Unit to hold Credit Card Issuer or Bank phone numbers) to dial a given Card Issuer or Bank computer Mainframe. When the Mainframe answers with a recorded greeting message, it instructs the Consumer to press the “Send” key on the “SHIFT” Unit. After having received the information, and if sufficient credit is available, the Mainframe responds with a “Transaction Complete” message. If there are insufficient credit funds available or if some other problem exists, then an appropriate message is given by the Issuer Mainframe.

The Credit Card or Bank Mainframe then creates a “Pay To” data string consisting of the following: the Vendor's “Deposit Only Account Number”; the “Invoice Number”; the “Price”, with the Issuer Mainframe adding the Consumer's “Bill To Address”; “Escrowed Approval Number” and the Consumer's “Credit Card Number”, (which is kept confidential and is only for “Internal Use” in the case where a “Refund” must be given). (See “Credit Card Purchase” Flow Chart). This “Pay To” data string is then sent to the Vendor's Terminal Issuer Mainframe.

When the Vendor's Terminal Issuer Mainframe receives the “Pay To” data string, it employs the field containing the Vendor's Account Number to open the Vendor's Account and the balance of the data string information is deposited into the Vendor's Account, in the exact same process and amount of time as a current Credit Card Approval number is transmitted to a Vendor with the current Credit Card System. (See Credit Card and Vendor Terminal Flow Charts).

The Vendor's mainframe holds the received funds in escrow and notifies the Vendor Terminal that payment was received for the given Invoice number.

When the Vendor receives notification that a “Pay To” order was received for any given Invoice, the Vendor is then able to confidently ship the item [s]. Once the Vendor obtains the FedEx, USPS, or UPS shipping number, the Vendor keys that shipping number into the Customer “Pay To” data string in his terminal and sends the information to the mainframe, at any time or at the end of the business day, in the same manner as current credit card sales are verified at any time or tabulated at the end of the business day.

When the Invoice data string with the shipping number is sent to the mainframe, the mainframe is programmed to use the Internet to contact the FedEx, USPS, UPS package tracking site to confirm that the shipping number matches a package currently in shipment. If the shipping number is verified, then the mainframe releases the Escrowed funds into the Vendor's account for the Vendor's use. This prevents frauds where Vendors accept funds for products they do not have available for instant shipping, or where other frauds are involved.

### STATEMENT REGARDING FEDERALLY SPONSORED RESEARCH OR DEVELOPMENT

Not Applicable

### REFERENCE TO A MICROFICHE APPENDIX

Not applicable

### BACKGROUND OF THE INVENTION

All prior art attempts to create a viable security system to prevent the theft of Credit Card numbers on the Internet have failed due to “hackers” finding methods of intruding into such prior art security systems and stealing and misusing Credit Card numbers.

The primary reason that all prior attempts at security have failed, is that the systems attempt to have Consumers give their Credit Card numbers to make payments for purchases over the Internet where they remain vulnerable to “hackers” despite all forms of encryption procedures.

The two best systems currently available are the American Express and Discover Card system of a Credit Card holder employing a computer to go to the American Express or Discover Card Internet site and calling up a program which allows the Cardholder to request a “temporary” “one time use” Credit Card number for a specific amount of money. The Card holder must then insert their real Credit Card number into this called up program so that the “temporary” card number and amount may be charged to the Card holder's primary account.

In both the above instances, “hackers” have been able to track the called up American Express or Discover Card program to the Card holder's computer and copy the Card holder's real Card number, as the Card holder is inputting the information into the program.

Under all existing systems, unscrupulous Vendors are able to double, triple bill, or bleed out a Card holder's credit account, once the Vendor has the Credit Card holders account number.

The “SHIFT” Credit Card Internet Security System is superior to all prior art attempts to solve the Internet security problems of Credit Card numbers being stolen by “hackers”, primarily because the “SHIFT” System permits Card holders to make purchases on the Internet without giving out their Credit Card number to any Vendor, while permitting the Card holder to make payments to specific Vendors by the Card holder instructing the Credit Card Issuer Mainframe to make a payment to a specific Vendor's Deposit Only Account Number in an exact amount that is specified by the Card holder via employing the “SHIFT” Unit and the Card holder's telephone line.

The “SHIFT” Unit also permits Electronic Banking and Bill Paying without the use of a computer and is superior to existing telephone banking procedures because “Voice Menu” systems are not used. Because of not requiring a computer, the “SHIFT” System permits all persons to do electronic banking and bill paying and permits all persons having a bank account to receive EFT (electronic fund transfer) payments into their accounts.

Non-Internet Electronic Banking System:

The exact same “SHIFT” Unit is employed to obtain bank account balances; make electronic bill payments, or to make account to account transactions without employing a computer. The First flap of the cover of the “SHIFT” Unit contains the instructions for making a Credit Card Purchase, when the second flap is opened it contains all instructions for electronic banking transactions, all without the currently employed “Voice Menu” System currently used by Banks to facilitate banking by telephone, The “SHIFT” Security System employs “Caller ID” to protect bank accounts from unauthorized access. When a bank account is first opened, the Consumer supplies the Bank with one or two telephone numbers (home/office) from which the Consumer will primarily do their banking from. These phone numbers are then programmed into the Consumers account [s].

Whenever a Consumer attempts to do a transaction of any nature, the Bank mainframe employs “Caller ID” to note the phone number the call is being made from. The Bank mainframe then employs the account number to open the given account and compares the “Caller ID” number to those supplied by the Consumer. If the numbers match, a transaction is permitted to proceed.

If the phone number is different from those in the account, the Bank mainframe first disconnects the call without any form of message and next logs the number in the account where it will be supplied to the Consumer in the monthly statement, informing the Consumer that a person at that phone number attempted to enter the Consumers account at the specific date and time of the occurrence. A warning note is included in the statement that the Consumer ought not attempt to personally confront the person owning the number, and to either disregard the attempt or contact the Police if they wish to press criminal attempt charges.

To Obtain The Balance of a given account, the Consumer turns the “SHIFT” Unit on and then keys in the asterisk (“*”) symbol. The Consumer then “swipes” the bank card for that account or manually key in the account number and then enters their PIN. Once this process is complete, the Consumer dials the telephone number provided by the Bank. The Consumer will then hear a greeting and an instruction to press “Send” at the tone.

The Bank mainframe, having verified the phone number and PIN is correct, recognizing that the asterisk (“*”) symbol preceded the account number, obtains the balance and employs DTMF (Dual Tone Multi Frequency [telephone tones]) to send the balance to the Consumer's “SHIFT” Unit's LCD screen, after which the mainframe gives a “thank you transaction complete” message and terminates the call. Upon receiving the balance in the LCD, the Consumer is able to write the balance down and to then proceed with other electronic banking functions.

To Pay A Bill, the Consumer turns the “SHIFT” Unit on and “swipes” or keys in the number of the account that a payment is to be made from and then enters their PIN. The Consumer then keys in “Amount To Be Paid; the Deposit Only account number supplied on the Bill that is to be paid (future bills may contain magnetic strips containing the pay to account number and Consumer Invoice number and amount to be paid) and the Invoice number.

The Consumer then dials the telephone number provided by the Bank, where they receive a greeting message and a direction to press “Send” at the tone.

The Consumer's Bank mainframe employs the account number in the second field (the first field of all Units contains an electronic “handshake” PES [Participant Enabling Signal]) of the data string to open the given account. After verifying the telephone number and PIN, the Bank mainframe then employs the information to verify if there are sufficient funds in the account to make the payment, if not sufficient funds, it gives such a message and terminates the call.

If sufficient funds exist, the mainframe creates a “Pay To” data string with the account number that money is to be paid to, followed by the name of the Payor; the Invoice number; the amount that is being paid and the date and time (month/day/year/hour/minute/second [this becomes the new “Check” number]) the payment is being made, and then adds the Deposit Only account number of the Consumer account the payment is being made from, this for purpose of possible refunds. The Bank mainframe then adds this “Pay To” string to others that it will transmit to other Banks as payments. (See Banking Flow Chart).

The Consumer, after having pressed the “Send” button, in a matter of seconds receives a “Date/Time” check number in the LCD of the “SHIFT” Unit. The Consumer then writes this number in a “Check Stub” electronic payment check book along with the information of who the bill was paid to. The call is then terminated.

Account To Account Transfers are made by employing the same process used to pay bills with. This process can be used to transfer funds between a Consumers own accounts, or to send money to others accounts, whether as rent payments, or payments for E-Bay type purchases.

This electronic banking system, by employing Deposit Only Account Numbers for every account, also permits payments to be made into a Consumer's account, whether from the Government, or to receive rent payments if they own property, or for any other reason that money is to be paid to them from anyone having a bank account.

Emergency Bank Transactions when the account holder is not at their home or office numbers and may have to issue an emergency payment from one of their accounts, they are able to call bank personnel that are personally familiar with the individual and give a special password.

PES (Participant Enabling Signal) is built into the first “field” of the data string in every piece of “SHIFT” equipment, Consumer Units or Vendor Terminals and is part of the programming installed in every Bank mainframe, whether for Credit Card or Banking uses and serves as an “electronic handshake” so that only equipment or mainframes under contract can communicate with each other.

### CROSS REFERENCE TO RELATED APPLICATIONS

Not Applicable

### BRIEF SUMMARY OF THE INVENTION

The use of the disclosed “SHIFT” Internet Credit Card Security and Electronic Banking System by Credit Card issuers will drastically reduce (if not totally eliminate) Credit Card thefts and frauds, basically because no Credit Card numbers are ever given to any Vendor, on or off of the Internet.

The “SHIFT” System permits the Consumer to retain total control of what funds are disbursed from their Credit Card accounts, thereby generating absolute Consumer confidence that their Credit Card or Bank Account numbers will never be stolen and misused by “Hackers”.

Such absolute Consumer confidence will result in virtually One Hundred Percent (100%) of Credit Card holders using their Cards on the Internet, which ought cause Internet sales to skyrocket.

The use of the disclosed “SHIFT” System for electronic banking by virtually anyone having a bank account, will bring electronic banking to the fruition contemplated by the Banking Industry. Because no computer is needed, virtually anyone can begin employing electronic banking to pay their bills and do their normal banking functions immediately, thereby saving the Consumer the costs of checks, stamps and envelopes and the banking Industry the cost of processing paper checks.

### BRIEF DESCRIPTION OF THE SEVERAL VIEWS OF THE DRAWINGS

No Drawings Provided.

### DETAILED DESCRIPTION OF THE INVENTION

The disclosed “SHIFT” Unit and Internet Credit Card Security and Electronic Banking System consists of the small Unit that permits Consumers to never give out their Credit Card or Bank Account numbers to any Vendors and gives the Consumer absolute control of precise amounts to be paid to Vendors, thereby preventing multi billings or overcharging by Vendors.

See four (4) pages of “SPECIFICATION” for detailed description.

### ABSTRACT OF THE DISCLOSURE

See “BRIEF SUMMARY OF THE INVENTION” noted above.

[image]

[image]

[image]

1. A method which changes the current Credit Card “Vendor Take From” system to a “Cardholder Pay To” system where Credit Card purchases are made via the Internet (or in brick and mortar locations), but where Credit Card or Bank Account numbers are never given to any Vendor over the Internet. The “SHIFT” Internet Security System prevents thefts of Credit Card numbers or frauds and develops Consumer confidence by payment for purchase transactions made on the Internet being paid for with the use of the “SHIFT” Unit through a Consumer phone line directly to bank mainframes, totally bypassing the Internet and thus preventing theft or fraud of Credit Card or Bank Account Numbers from hackers on the Internet.

2. A method of Vendors and all Individual Bank Account holders being given a “Deposit Only Account Number” that can only accept deposits (a second or additional set of numbers are supplied to the account holder that enables withdrawals from a given account ) and where payments can be made to such Deposit Only Account Numbers by a Consumer using the “SHIFT” Unit and the Consumer's personal telephone line to direct the Credit Card or Bank Account Mainframe to make the payment to the Deposit Only Account of a specific Vendor or individual.

3. The creation of a small terminal that is supplied to every Credit Card or Bank Account holder that is capable of receiving purchase data from an Internet or telephone Vendor employing “DTMF” (Dual Tone Multi Frequency {Telephone Tones} [or other signaling system]) that can be transmitted and accepted or rejected by the Consumer while still connected to the Vendor. This data consists of the Vendor's Deposit Only Account Number; the Invoice Number (consisting of month/day/year/hour/minute/second/hyphen/terminal number {Example—Purchase date of Jul. 12, 2001, at 3:47:22 on Vendor Terminal number 4=071201154722-4} [if the Vendor employs more than one terminal]);
and the Cost Of Purchase, which is transmitted to the Unit's LCD where a Consumer must replicate the cost exactly before this Consumer verified cost input is then deposited in one of the fields in the Unit so as to prevent electronic transmission of a fraudulent amount.

4. A “SHIFT” (Secure Home Interactive Financial Transactor) consists of a 2″×4″×¾″ or similar size unit containing a numeric keypad, a twenty or more (20+) character LCD display screen and eight or more (8+) additional function keys for correcting or creating/sending electronically stored information in a seven or more (7+) field data string contained in the unit employing DTMF tones or other signaling systems. The Unit contains in and out telephone jacks and has a double fold cover. When the initial cover is opened, it contains all required instructions to make a Credit Card purchase. When the second flap of the cover is opened, it contains all instructions for all electronic banking processes. The first “field” in all “SHIFT” Units data strings contain a Participant Enabler Signal (PES) that serves as an “Electronic Handshake” with all participating Credit Card or Bank Mainframes to ensure only contracted users are employing the System.

5. A method of preventing Vendors from collecting payments for products that the Vendor does not have available to ship to the Consumer. The Vendor's Mainframe notifies the Vendor Terminal that a “Pay To” order was received but that the funds are held in Escrow by the Vendor's Mainframe until the Vendor supplies a FedEx, UPS, or USPS shipping number to the Invoice Number data string and returns the information to the Vendor's Mainframe. When a shipping number is received by the Vendor's Mainframe, it is programmed to employ the Internet to contact the specific shipper's “tracking” site to confirm that the given shipping number is in fact in transit. If confirmation is received, then the Vendor's Mainframe releases the Escrowed funds into the Vendor's account for the Vendor's use.

6. A method of employing the “SHIFT” Unit to perform electronic banking functions without the use of a computer and without the use of the “Voice Menu” systems currently used by Banks for telephone banking.
